(19) United States
(12) Patent Application Publication
(10) Pub. No.: US 2025/0093188 A1
(43) Pub. Date: Mar. 20, 2025

(54) AIR FLOW METER

(71) Applicant: HITACHI ASTEMO, LTD., Hitachinaka-shi, Ibaraki (JP)

(72) Inventors: Yushi ARAKI, Hitachinaka-shi, Ibaraki (JP); Masahiro MATSUMOTO, Hitachinaka-shi, Ibaraki (JP)

(73) Assignee: HITACHI ASTEMO, LTD., Hitachinaka-shi, Ibaraki (JP)

(21) Appl. No.: 18/729,544

(22) PCT Filed: Mar. 17, 2022
(86) PCT No.: PCT/JP2022/012324

§ 371 Date: Jul. 17, 2024

(51) Int. Cl. G01F 1/696

(52) U.S. Cl. CPC G01F 1/696

(57) ABSTRACT

The present disclosure provides an air flow meter capable of measuring a flow rate of air in a main passage with high accuracy even in an environment where pulsation of air in the main passage increases. The air flow meter includes a flow rate detection element, a calculation unit 121, a signal extraction unit 122, a first correction unit 123, and a coupling unit 124c. The flow rate detection element is installed in a sub-passage that takes air from the main passage and returns the air to the main passage, and outputs a detection signal DS corresponding to a flow rate of the air flowing through the sub-passage. The calculation unit 121 generates a detected flow rate Qo as an output signal corresponding to the flow rate of the air flowing through the main passage based on the detection signal DS. The signal extraction unit 122 extracts an AC component Qhpf of the detected flow rate Qo which is an output signal. The first correction unit 123 outputs a first correction amount Q1 that corresponds to a half-wave rectified wave of the AC component Qhpf and increases according to an increase in a pulsation amplitude ratio of the AC component Qhpf. The coupling unit 124c subtracts a correction amount CA based on the first correction amount Q1 from the detected flow rate Qo as the output signal.

### TECHNICAL FIELD

The present disclosure relates to an air flow meter.

### BACKGROUND ART

Conventionally, a device that measures a flow rate of a fluid such as air is known. A flow rate measurement device described in Patent Literature 1 below includes a detection element that outputs a non-linear signal corresponding to a flow rate. The flow rate measurement device includes a first signal processing system, a second signal processing system, an amplifier, and a correction unit (Abstract, claim 1, paragraphs 0015 to 0019, etc.).

The first signal processing system performs filter processing on a non-linear source signal of the detection element, and then performs sensitivity adjustment to obtain a first signal. The second signal processing system linearizes the source signal, performs filter processing on the linearized source signal, performs sensitivity adjustment, and performs non-linearization again to obtain a second signal. The amplifier amplifies a difference signal between the first signal and the second signal. The correction unit uses the amplified difference signal to correct the source signal.

### CITATION LIST

### Patent Literature

PTL 1: JP 2007-205916 A

### SUMMARY OF INVENTION

### Technical Problem

The air flow meter is installed in, for example, an intake passage of an internal combustion engine vehicle, and measures a flow rate of air flowing through the intake passage. In an internal combustion engine vehicle, a high-performance system has been developed by reducing the number of cylinders by downsizing, increasing the capacity of exhaust gas recirculation (EGR), adopting the Atkinson cycle, and the like.

Therefore, the pulsation of the air in the intake passage tends to increase due to the expansion of the backflow generation region of the air due to the blowback from the EGR valve and the expansion of the valve overlap due to the reduction in the number of cylinders. As described above, the air flow meter is required to measure the flow rate of the air with high accuracy even in an environment where the pulsation of the air is increasing.

The present disclosure provides an air flow meter capable of measuring a flow rate of air with high accuracy even in an environment where pulsation of air is increasing.

### Solution to Problem

An aspect of the present disclosure is an air flow meter that measures a flow rate of air flowing through a main passage, the air flow meter including: a flow rate detection element that is installed in a sub-passage that takes the air from the main passage and returns the air to the main passage, and outputs a detection signal corresponding to a flow rate of the air flowing through the sub-passage; a calculation unit that generates an output signal corresponding to a flow rate of air flowing through the main passage based on the detection signal; a signal extraction unit that extracts an AC component of the output signal; a first correction unit that outputs a first correction amount corresponding to a half-wave rectified wave of the AC component and increasing according to an increase in a pulsation amplitude ratio of the air flowing through the main passage; and a coupling unit that subtracts a correction amount based on the first correction amount from the output signal.

### Advantageous Effects of Invention

According to the above aspect of the present disclosure, it is possible to provide the air flow meter capable of measuring the flow rate of the air with high accuracy even in an environment where the pulsation of the air is increased.

### BRIEF DESCRIPTION OF DRAWINGS

FIG. 1 is a schematic cross-sectional view illustrating a first embodiment of an air flow meter according to the present disclosure.

FIG. 2 is a rear view of a physical quantity detector illustrated in FIG. 1 from which a cover is removed.

FIG. 3 is an enlarged cross-sectional view taken along line III-III of the air flow meter of the physical quantity detector of FIG. 2.

FIG. 4 is a graph showing a relationship between an output signal of the air flow meter of FIG. 3 and a true flow rate.

FIG. 5 is a graph showing an error between an output signal of the air flow meter of FIG. 3 and a true flow rate.

FIG. 6 is a graph showing an error between an output signal of the air flow meter of FIG. 3 and a true flow rate.

FIG. 7 is a graph illustrating a flow of air in a sub-passage of the physical quantity detector of FIG. 2.

FIG. 8 is a block diagram of a signal processing unit of the air flow meter of FIG. 3.

FIG. 9 is a graph for explaining signal processing by the signal processing unit of FIG. 8.

FIG. 10 is a graph illustrating an example of a change in a correction amount by the signal processing unit of FIG. 8.

FIG. 11 is a graph showing an error between a corrected flow rate and a true flow rate by the signal processing unit of FIG. 8.

FIG. 12 is a block diagram of a signal processing unit of a second embodiment of the air flow meter according to the present disclosure.

### DESCRIPTION OF EMBODIMENTS

Hereinafter, an embodiment of an air flow meter according to the present disclosure will be described with reference to the drawings.

### First Embodiment

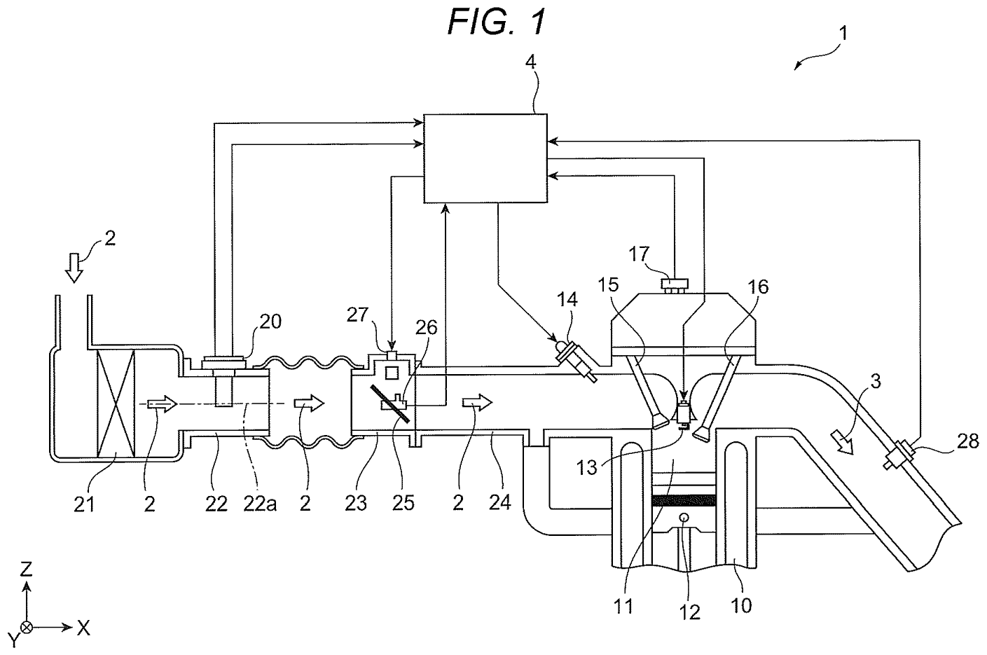

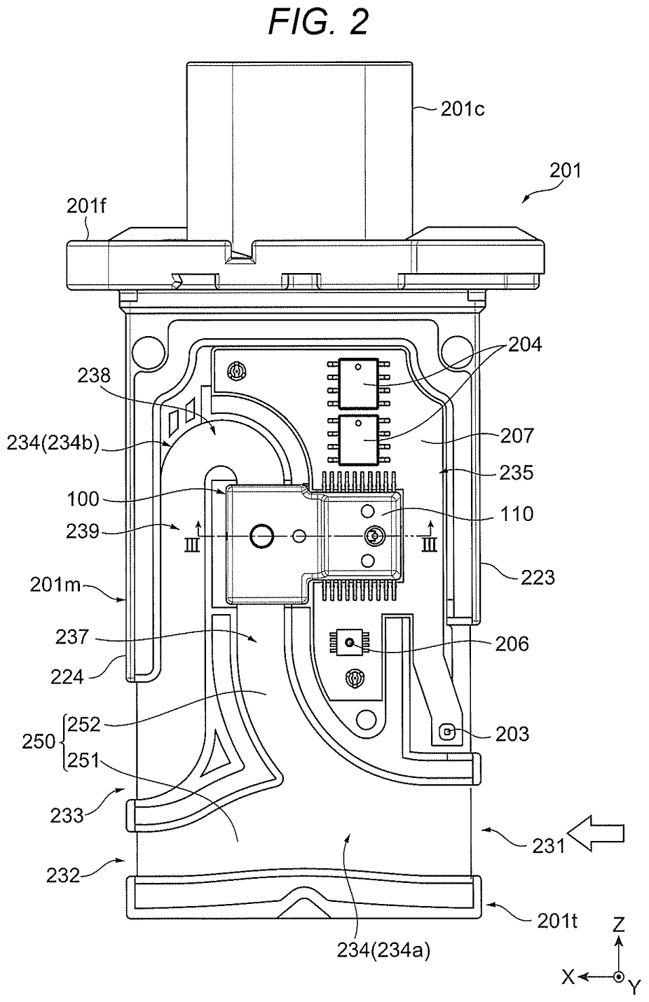

FIG. 1 is a schematic cross-sectional view of an internal combustion engine control system 1 as a first embodiment of an air flow meter according to the present disclosure. An air flow meter 100 (see FIG. 2) of the present embodiment constitutes, for example, a part of a physical quantity detector 20 included in the internal combustion engine control system 1. Hereinafter, configurations of each unit of the internal combustion engine control system 1, the physical quantity detector 20, and the air flow meter 100 of the present embodiment will be described.

In the internal combustion engine control system 1, for example, intake air is taken in from an air cleaner 21 based on the operation of an internal combustion engine 10 including an engine cylinder 11 and an engine piston 12. The intake air is guided to a combustion chamber of the engine cylinder 11 via an intake body which is a main passage 22, a throttle body 23, and an intake manifold 24.

The physical quantity detector 20 installed in the main passage 22 measures the physical quantity of the intake air. That is, measurement target gas 2 of the physical quantity detector 20 is, for example, intake air flowing through the main passage 22. Further, fuel is supplied from a fuel injection valve 14 based on the physical quantity of the intake air measured by the physical quantity detector 20, and is guided to a combustion chamber in a state of an air-fuel mixture together with the intake air.

The fuel injection valve 14 is provided, for example, in an intake port of the internal combustion engine 10, and injects fuel into the intake port to mix the fuel with intake air, so that an air-fuel mixture of the fuel and the intake air is guided to the combustion chamber via an intake valve 15. The air-fuel mixture guided to the combustion chamber is explosively burned by spark ignition of an ignition plug 13 to generate mechanical energy.

The physical quantity detector 20 measures physical quantities such as a flow rate, temperature, humidity, and pressure of intake air as the measurement target gas 2 taken in through the air cleaner 21 and flowing through the main passage 22. The physical quantity detector 20 outputs an electric signal corresponding to the physical quantity of the intake air. An output signal of the physical quantity detector 20 is input to a controller 4.

In addition, an output of a throttle angle sensor 26 that measures the opening of a throttle valve 25 is input to the controller 4. In order to measure the positions and states of the engine piston 12, the intake valve 15, and an exhaust valve 16 of the internal combustion engine 10, and the rotational speed of the internal combustion engine 10, the output of a rotational angle sensor 17 is input to the controller 4. In order to measure the state of the mixing ratio of the fuel amount and the air amount from the state of exhaust gas 3, the output of an oxygen sensor 28 is input to the controller 4.

The controller 4 calculates the fuel injection amount and the ignition timing based on the physical quantity of the intake air which is the output of the physical quantity detector 20 and the rotational speed of the internal combustion engine 10 obtained from the output of the rotational angle sensor 17. The amount of fuel supplied from the fuel injection valve 14 and the ignition timing by the ignition plug 13 are controlled based on these calculation results. Further, the fuel supply amount and the ignition timing are finely controlled based on the temperature measured by the physical quantity detector 20, the change state of the throttle angle, the change state of the engine rotational speed, the state of the air-fuel ratio measured by the oxygen sensor 28, and the like.

The controller 4 further controls the amount of air bypassing the throttle valve 25 by an idle air control valve 27 in the idle operation state of the internal combustion engine 10, and controls the rotational speed of the internal combustion engine 10 in the idle operation state. Both the fuel supply amount and the ignition timing, which are main control amounts of the internal combustion engine 10, are calculated using the output of the physical quantity detector 20 as a main parameter. Therefore, it is important to improve the accuracy of the physical quantity detector 20, suppress the change with time, and improve the reliability for improving the control accuracy of the vehicle and securing the reliability.

In particular, in recent years, demands for fuel saving of vehicles are very high, and demands for exhaust gas purification are very high. In order to meet these demands, it is extremely important to improve the measurement accuracy of the physical quantity of the intake air as the measurement target gas 2 measured by the physical quantity detector 20. In addition, it is also important that the physical quantity detector 20 maintains the high reliability.

Furthermore, in recent years, a high-performance system has been developed by reducing the number of cylinders by downsizing an internal combustion engine vehicle, increasing the capacity of exhaust gas recirculation (EGR), adopting the Atkinson cycle, and the like. Therefore, the pulsation of the air in the intake passage tends to increase due to the expansion of the backflow generation region of the air due to the blowback from the EGR valve and the expansion of the valve overlap due to the reduction in the number of cylinders of the internal combustion engine 10. As described above, the air flow meter constituting the physical quantity detector 20 is required to measure the flow rate of the air with high accuracy even in an environment where the pulsation of the air is increasing.

FIG. 2 is a rear view of the physical quantity detector 20 illustrated in FIG. 1 from which a cover is removed. The physical quantity detector 20 includes a housing 201 and a cover (not illustrated) attached to the housing 201. The cover is formed of, for example, a plate-like member made of a conductive material such as an aluminum alloy, an injection-molded synthetic resin material, or the like, and is formed in a thin plate shape having a wide flat cooling surface.

The housing 201 is made of, for example, an injection-molded synthetic resin material. The housing 201 includes a flange 201f, a connector 201c, and a measurement unit 201m.

The flange 201f is fixed to the intake body that is the main passage 22. The flange 201f has, for example, a substantially rectangular plate shape in plan view, and has a through hole at a corner. For example, the flange 201f is fixed to the main passage 22 by inserting a fixing screw into a through hole at a corner and screwing the fixing screw into a screw hole of the main passage 22.

The connector 201c protrudes from the flange 201f and is exposed to the outside from the intake body for electrical connection with an external device. For example, four external terminals and a correction terminal are provided inside the connector 201c. The external terminals are a terminal for outputting a physical quantity such as a flow rate or a temperature which is a measurement result of the physical quantity detector 20, and a power supply terminal for supplying DC power for operating the physical quantity detector 20. The correction terminal is used to measure the manufactured physical quantity detector 20, obtain a correction value related to each physical quantity detector 20, and store the correction value in a memory inside the physical quantity detector 20.

The measurement unit 201m extends from the flange 201f so as to protrude toward the center of the main passage 22. The measurement unit 201m has a thin and long plate-like shape extending from the flange 201f toward the center of the main passage 22, and has a wide front surface and a wide back surface, and an upstream end surface 223 and a downstream end surface 224 which are a pair of narrow side surfaces. In FIGS. 1 and 2, a three-dimensional orthogonal coordinate system including an X axis parallel to a central axis 22a of the main passage 22 and the short direction of the measurement unit 201m, a Y axis parallel to the thickness direction of the measurement unit 201m, and a Z axis parallel to the longitudinal direction of the measurement unit 201m is displayed.

The measurement unit 201m protrudes from the inner wall of the main passage 22 toward the central axis 22a of the main passage 22 in a state where the physical quantity detector 20 is attached to the main passage 22, and the front surface and the back surface are arranged in parallel along the central axis 22a of the main passage 22. The measurement unit 201m is arranged such that among the narrow upstream end surface 223 and the narrow downstream end surface 224, the upstream end surface 223 on one side in the short direction of the measurement unit 201m faces the upstream side of the main passage 22, and the downstream end surface 224 on the other side in the short direction of the measurement unit 201m faces the downstream side of the main passage 22.

In the measurement unit 201m, an inlet 231 for taking a part of the measurement target gas 2 such as intake air into the sub-passage 234 in the measurement unit 201m is provided on the upstream end surface 223 of a distal end portion 201t opposite to the flange 201f provided at the proximal end portion. In addition, the measurement unit 201m is provided with a first outlet 232 and a second outlet 233 for returning the measurement target gas 2 taken into the sub-passage 234 in the measurement unit 201m to the main passage 22 on the downstream end surface 224 opposite to the upstream end surface 223 of the distal end portion 201t.

In the physical quantity detector 20, the inlet 231 of the sub-passage 234 is provided at the distal end portion 201t of the measurement unit 201m extending from the flange 201f toward the center of the main passage 22. Therefore, the physical quantity detector 20 can take the gas not in the vicinity of the inner wall surface of the main passage 22 but in a portion close to the central portion away from the inner wall surface into the sub-passage. As a result, the physical quantity detector 20 can measure the flow rate of the gas in the portion away from the inner wall surface of the main passage 22, and can suppress the decrease in accuracy due to the influence of heat or the like.

The measuring unit 201m is provided with a sub-passage groove 250 for forming the sub-passage 234 and a circuit chamber 235 for accommodating a circuit board 207. The circuit chamber 235 and the sub-passage groove 250 are provided in a concave shape on one surface of the measurement unit 201m in the thickness direction of the plate-shaped measurement unit 201m.

The circuit chamber 235 is disposed at a position on the upstream side in the flow direction of the measurement target gas 2 in the main passage 22, and the sub-passage 234 is disposed at a position on the downstream side in the flow direction of the measurement target gas 2 in the main passage 22 with respect to the circuit chamber 235. The sub-passage groove 250 forms the sub-passage 234 together with the cover. The sub-passage groove 250 includes a first sub-passage groove 251 and a second sub-passage groove 252 branching in the middle of the first sub-passage groove 251.

The first sub-passage groove 251 is formed to extend along the short direction of the measurement unit 201m between the inlet 231 opened to the upstream end surface 223 of the measurement unit 201m and the first outlet 232 opened to the downstream end surface 224 of the measurement unit 201m. The first sub-passage groove 251 forms, between the cover and the first sub-passage groove, a first sub-passage 234a extending from the inlet 231 along the central axis 22a of the main passage 22 to the first outlet 232. The first sub-passage 234a takes the measurement target gas 2 flowing in the main passage 22 from the inlet 231, and returns the taken measurement target gas 2 from the first outlet 232 to the main passage 22. The first sub-passage 234a has a branch portion between the inlet 231 and the first outlet 232.

The second sub-passage groove 252 forms, between the cover and the second sub-passage groove, a second sub-passage 234b that branches from the first sub-passage 234a toward the flange 201f and reaches the second outlet 233. The second outlet 233 is opened to face the downstream side in the flow direction of the measurement target gas 2 in the main passage 22. The second outlet 233 has an opening area larger than that of the first outlet 232, and is formed closer to the proximal end side in the longitudinal direction of the measurement unit 201m than the first outlet 232. The second sub-passage 234b has, for example, a linear upstream portion 237, an arc-shaped or U-shaped curved portion 238, and a linear downstream portion 239, and has a path that reciprocates along the longitudinal direction of the measurement unit 201m.

More specifically, the second sub-passage groove 252 forming the second sub-passage 234b branches in the longitudinal direction of the measurement unit 201m from the first sub-passage groove 251 toward the flange 201f, for example, and extends in a direction substantially orthogonal to the central axis 22a of the main passage 22. For example, the second sub-passage groove 252 is curved in a U shape or an arc shape toward the distal end portion 201t in the vicinity of the flange 201f of the measurement unit 201m and folded back, and extends in the longitudinal direction of the measurement unit 201m, that is, in a direction orthogonal to the central axis 22a of the main passage 22. Further, the second sub-passage groove 252 is bent so as to curve in an arc shape toward the downstream end surface 224 of the measurement unit 201m, for example, and is connected to the second outlet 233.

The measurement target gas 2 flowing through the main passage 22 illustrated in FIG. 1 is taken into the first sub-passage 234a from the inlet 231 during forward flow, and flows through the first sub-passage 234a toward the first outlet 232. The measurement target gas 2 flowing in the first sub-passage 234a flows into the second sub-passage 234b from the branch portion of the first sub-passage 234a during forward flow. The measurement target gas 2 that has branched from the first sub-passage 234a and flowed into the second sub-passage 234b passes through the second sub-passage 234b and returns from the second outlet 233 to the main passage 22.

The physical quantity detector 20 includes, for example, an air flow meter 100 disposed in the upstream portion 237 of the second sub-passage 234b as a detection element that detects a physical quantity. More specifically, in the upstream portion 237 of the second sub-passage 234b, the air flow meter 100 is disposed between the first sub-passage 234a and the curved portion 238. Since the second sub-passage 234b has the curved shape as described above, the passage length can be secured longer, and when pulsation occurs in the measurement target gas 2 in the main passage 22, the influence on the air flow meter 100 can be reduced. Details of the air flow meter 100 of the present embodiment will be described later.

The circuit board 207 is accommodated in the circuit chamber 235 provided on one side in the short direction of the measurement unit 201m. The circuit board 207 has, for example, a generally L-shape extending along the longitudinal direction of the measuring unit 201m and extending along the short direction of the measuring unit 201m at the end of the measurement unit 201m on the flange 201f side.

On the surface of the circuit board 207, an intake air temperature sensor 203, a pressure sensor 204, a humidity sensor 206, and a chip package 110 constituting the air flow meter 100 are mounted. That is, the physical quantity detector 20 includes, for example, an intake air temperature sensor 203, a pressure sensor 204, an air flow meter 100, and a humidity sensor 206 as elements that detect a temperature, a pressure, a flow rate, and humidity which are physical quantities of the measurement target gas 2.

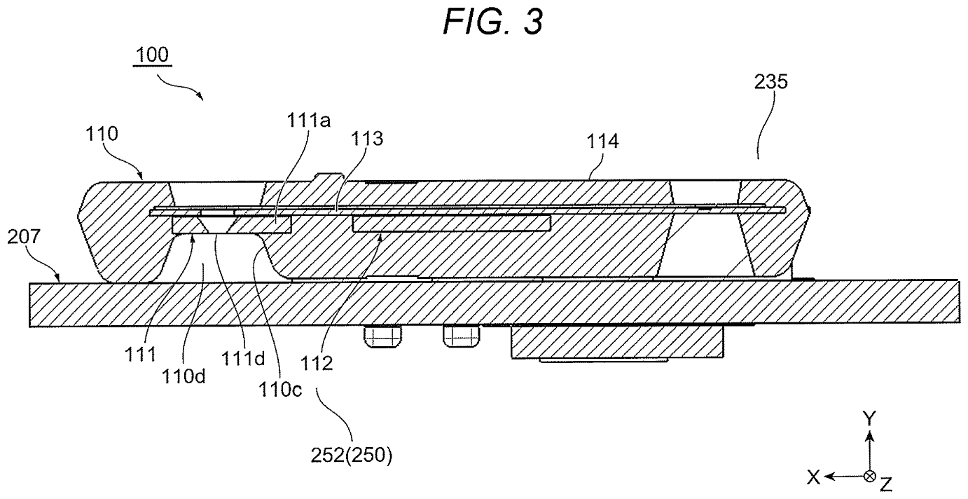

FIG. 3 is an enlarged cross-sectional view taken along line III-III illustrated in FIG. 2 of the air flow meter 100 constituting the physical quantity detector 20. The chip package 110 constituting the air flow meter 100 includes a flow rate detection element 111 that outputs a detection signal corresponding to the flow rate of the air flowing through the sub-passage 234. The flow rate detection element 111 is, for example, a thermal flow rate sensor, and includes a semiconductor substrate 111a and a diaphragm 111d formed on the front surface side of the semiconductor substrate 111a.

Although not illustrated, the diaphragm 111d includes, for example, a pair of temperature sensors disposed on the upstream side and the downstream side in the flow direction of the measurement target gas 2, and a heater disposed between the pair of temperature sensors. The flow rate detection element 111 measures the flow rate of the measurement target gas 2, for example, by detecting a temperature difference generated in the pair of temperature sensors by the flow of the measurement target gas 2 along the diaphragm 111d.

The flow rate detection element 111 measures, for example, the flow rate of the measurement target gas 2 flowing through a measurement flow path 110d formed between the circuit board 207 and a recessed groove 110c of the chip package 110. As illustrated in FIG. 2, the measurement flow path 110d is formed between the curved portion 238 of the second sub-passage 234b constituting the sub-passage 234 and the upstream portion 237.

The chip package 110 includes, for example, an electronic component 112, a lead frame 113, and a resin sealing portion 114. The electronic component 112 is mounted on the lead frame 113 together with the flow rate detection element 111. The electronic component 112 is, for example, an LSI, and is connected to the flow rate detection element 111 via a bonding wire to drive the flow rate detection element 111.

The resin sealing portion 114 is integrally molded by, for example, transfer molding of a thermosetting resin, and seals a part of the flow rate detection element 111, the electronic component 112, and a part of the lead frame 113. The diaphragm 111d of the flow rate detection element 111 and a part of the lead frame 113 are exposed from the resin sealing portion 114. The outer lead of the lead frame 113 exposed from the resin sealing portion 114 is connected to a terminal on the surface of the circuit board 207 as illustrated in FIG. 2.

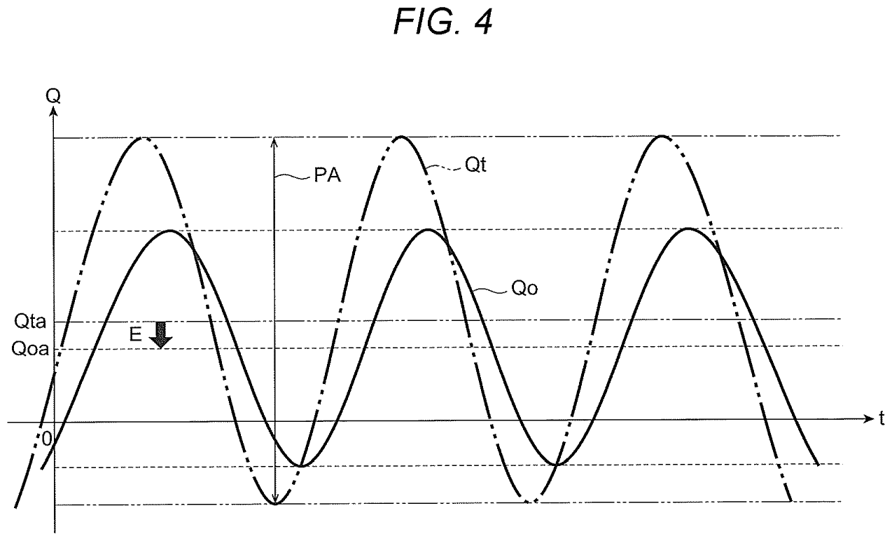

FIG. 4 is a graph illustrating an example of a relationship between a detected flow rate Qo, which is an output signal of the air flow meter 100, and a true flow rate during pulsation of the air flowing through the main passage 22 of the internal combustion engine control system 1. In the graph of FIG. 4, the vertical axis represents the flow rate Q, and the horizontal axis represents the time t. In FIG. 4, a true flow rate Qt of the air flowing through the main passage 22 is represented by a two-dot chain line, and a detected flow rate Qo which is an output signal of the air flow meter 100 installed in the sub-passage 234 of the physical quantity detector 20 is represented by a solid line.

In the example illustrated in FIG. 4, the true flow rate Qt of the air flowing through the main passage 22 of the internal combustion engine control system 1 regularly repeats a forward flow in which the flow rate Q becomes positive and a backflow flow in which the flow rate Q becomes negative alternately, and pulsation occurs in the air flowing through the main passage 22. On the other hand, the amplitude of the detected flow rate Qo of the air flow meter 100 is attenuated more than the true flow rate Qt, and the phase of the vibration is delayed more than the true flow rate Qt.

Here, at the time of pulsation of the air flowing through the main passage 22, a ratio of the pulsation amplitude PA to the average value Qta of the true flow rate Qt of the air flowing through the main passage 22 is defined as a pulsation amplitude ratio PAR. That is, the pulsation amplitude ratio PAR of the air flowing through the main passage 22 can be obtained by the following Formula (1) using, for example, the pulsation amplitude PA of the true flow rate Qt of the air flowing through the main passage 22 and the average value Qta.

$$PAR [ \% ] = ( PA / Qta ) \times 100 \qquad ( 1 )$$

Further, a difference between the average value Qoa of the detected flow rates Qo of the air flow meter 100 and the average value Qta of the true flow rate Qt is defined as an error E of the detected flow rate Qo of the air flow meter 100. Here, at the time of pulsation of the air flowing through the main passage 22, a ratio of the error E to the average value Qta of the true flow rate Qt of the air is defined as a pulsation error PAE. That is, the pulsation error PAE can be obtained by the following Formula (2) using, for example, the error E and the average value Qta of the true flow rate Qt of the air flowing through the main passage 22.

$$PAE [ \% ] = ( E / Qta ) \times 100 \qquad ( 2 )$$

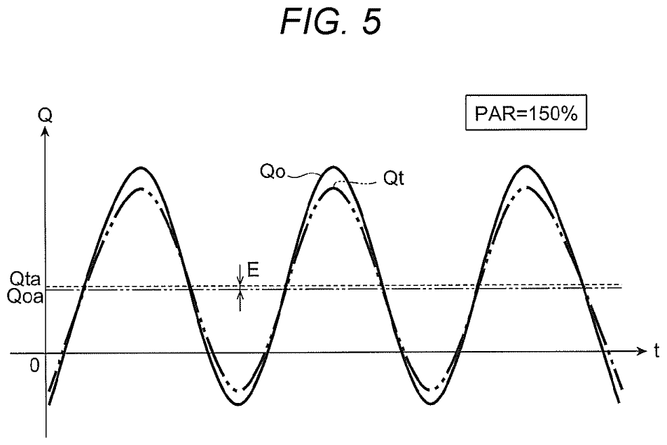

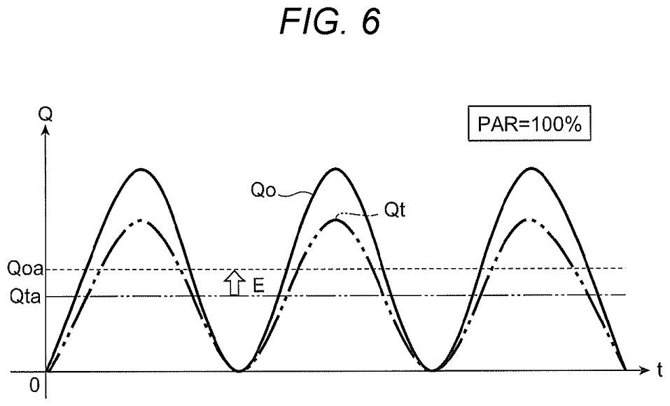

FIGS. 5 and 6 are graphs illustrating an example of an error E of the detected flow rate Qo, which is an output signal of the air flow meter 100, with respect to the true flow rate Qt of the air flowing through the main passage 22. In FIG. 5, the true flow rate Qt of the air and the detected flow rate Qo of the air flow meter 100 when the pulsation amplitude ratio PAR is 150% are represented by a two-dot chain line and a solid line, respectively. In FIG. 6, the true flow rate Qt of the air and the detected flow rate Qo of the air flow meter 100 when the pulsation amplitude ratio PAR is 100% are represented by a two-dot chain line and a solid line, respectively.

As illustrated in FIG. 5, when the pulsation amplitude ratio PAR is 150%, the detected flow rate Qo of the air flow meter 100 follows the true flow rate Qt relatively well. As a result, the error E of the average value Qoa of the detected flow rates Qo of the air flow meter 100 with respect to the average value Qta of the true flow rates Qt of the air is substantially 0. For example, when the pulsation amplitude ratio PAR exceeds 100%, the error E approaches 0.

On the other hand, as illustrated in FIG. 6, when the pulsation amplitude ratio PAR is 100%, the positive error of the detected flow rate Qo with respect to the true flow rate Qt increases as the detected flow rate Qo of the air flow meter 100 approaches the maximum value. As a result, the error E of the average value Qoa of the detected flow rates Qo of the air flow meter 100 with respect to the average value Qta of the true flow rates Qt of the air when the pulsation amplitude ratio PAR is 100% is larger than that when the pulsation amplitude ratio PAR is 150%.

As described above, the positive error of the detected flow rate Qo of the air flow meter 100 with respect to the true flow rate Qt tends to increase, for example, in the low pulsation amplitude region where the pulsation amplitude ratio PAR is 100% or less as compared with the high pulsation amplitude region where the pulsation amplitude ratio PAR exceeds 100%.

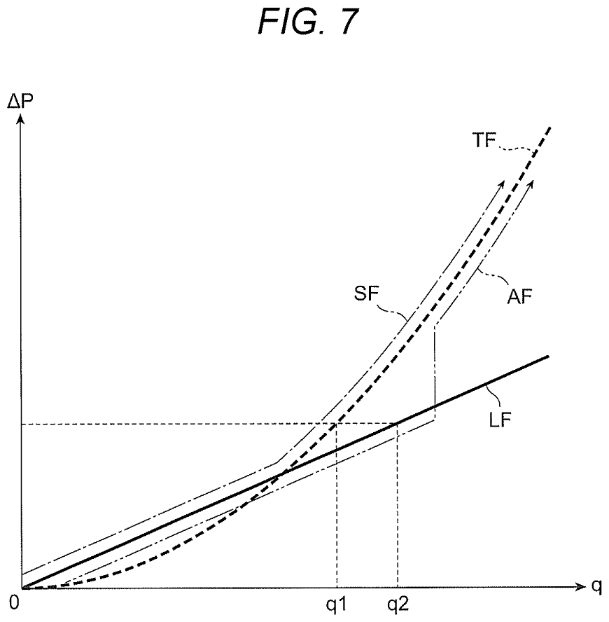

Hereinafter, the reason why the positive error of the detected flow rate Qo of the air flow meter 100 with respect to the true flow rate Qt increases in the low pulsation amplitude region where the pulsation amplitude ratio PAR of the air flowing through the main passage 22 is 100% or less will be described with reference to FIG. 7. FIG. 7 is a graph illustrating transition from a laminar flow to a turbulent flow of air flowing through the sub-passage 234 of the physical quantity detector 20 of FIG. 2.

In the graph of FIG. 7, the horizontal axis represents the flow rate q of the air flowing through the second sub-passage 234b of the physical quantity detector 20, and the vertical axis represents the differential pressure ΔP between the inlet 231 and the second outlet 233 of the physical quantity detector 20. In the graph of FIG. 7, the condition under which the air flowing through the second sub-passage 234b becomes the laminar flow LF is indicated by a solid line, and the condition under which the air flowing through the second sub-passage 234b becomes the turbulent flow TF is indicated by a broken line.

As illustrated in FIG. 1, when air as the measurement target gas 2 flows in the main passage 22 of the internal combustion engine control system 1, a differential pressure ΔP is generated between the inlet 231 of the physical quantity detector 20 illustrated in FIG. 2 and the first outlet 232 and the second outlet 233. As a result, air having a flow rate q corresponding to the differential pressure ΔP flows through the second sub-passage 234b between the inlet 231 and the second outlet 233 of the physical quantity detector 20.

When the air flowing through the main passage 22 is a steady flow SF, the flow rate q of the air flowing through the second sub-passage 234b continuously increases with an increase in the differential pressure ΔP as indicated by an alternate long and short dash line arrow in FIG. 7, and the air flow transitions from the laminar flow LF to the turbulent flow TF. On the other hand, when the air flowing through the main passage 22 is an acceleration flow AF, as indicated by a two-dot chain line arrow in FIG. 7, the flow rate q at which the air flowing through the second sub-passage 234b transitions from the laminar flow LF to the turbulent flow TF is increased as compared with the case of the steady flow SF indicated by a one-dot chain line.

In the case of the acceleration flow AF, when the differential pressure ΔP further increases, the differential pressure ΔP increases without increasing the flow rate q of the air flowing through the second sub-passage 234b, and the air flowing through the second sub-passage 234b transitions from the laminar flow LF to the turbulent flow TF. Therefore, even when the differential pressure ΔP is the same, the flow rate q2 of the air flowing through the second sub-passage 234b when the air flowing through the main passage 22 is the acceleration flow AF is larger than the flow rate q1 of the air flowing through the second sub-passage 234b when the air flowing through the main passage 22 is the steady flow SF.

As illustrated in FIG. 6, for example, in a low pulsation amplitude region where the pulsation amplitude ratio PAR of the true flow rate Qt of the air flowing through the main passage 22 is 100% or less, the acceleration flow AF is likely to occur in the main passage 22. On the other hand, as illustrated in FIG. 5, for example, in a high pulsation amplitude region where the pulsation amplitude ratio PAR of the true flow rate Qt of the air flowing through the main passage 22 exceeds 100%, the acceleration flow AF is hard to occur in the main passage 22.

As a result, in the low pulsation amplitude region, the flow rate q of the air flowing through the sub-passage 234 increases more than in the high pulsation amplitude region, and a positive error is likely to occur between the true flow rate Qt and the detected flow rate Qo of the air flow meter 100. Therefore, in the air flow meter 100, it is important to reduce a positive error generated between the true flow rate Qt and the detected flow rate Qo of the air flow meter 100 in the low pulsation amplitude region of the air flowing through the main passage 22.

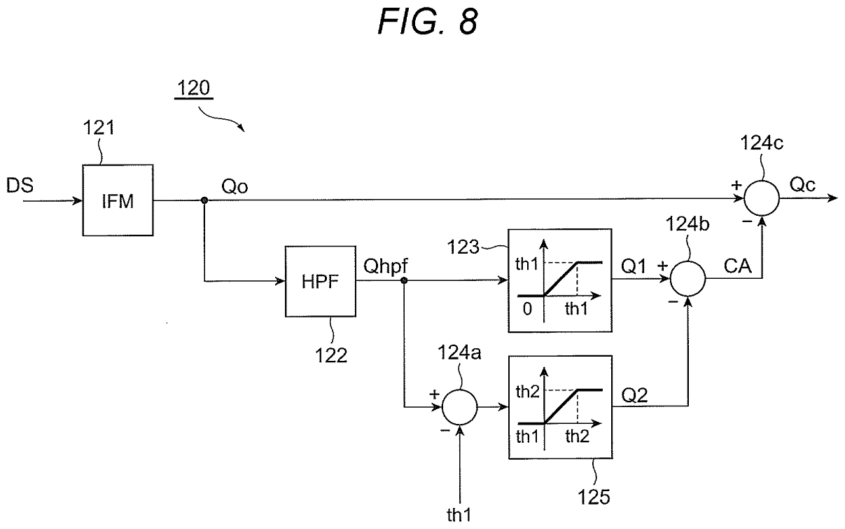

FIG. 8 is a block diagram of a signal processing unit 120 of the air flow meter 100 of the present embodiment. The signal processing unit 120 can include, for example, an electronic component 112 of the chip package 110, a program stored in a memory, and an electronic component such as a central processing unit (CPU) mounted on the circuit board 207 of the physical quantity detector 20.

The signal processing unit 120 includes, for example, a calculation unit 121, a signal extraction unit 122, a first correction unit 123, and coupling units 124a, 124b, and 124c. Furthermore, in the present embodiment, the signal processing unit 120 further includes, for example, a second correction unit 125.

As described above, the flow rate detection element 111 of the air flow meter 100 outputs a detection signal DS corresponding to the flow rate of the air flowing through the sub-passage 234 of the physical quantity detector 20. The detection signal DS output from the flow rate detection element 111 is input to the calculation unit 121. The calculation unit 121 outputs a detected flow rate Qo, which is an output signal corresponding to the flow rate of the air flowing through the main passage 22, based on the input detection signal DS.

For example, the calculation unit 121 calculates the detected flow rate Qo as the output signal from the detection signal DS using an inverse function model IFM. The inverse function model IFM is a calculation model for performing known inverse function correction described in Japanese Patent Application Laid-Open No. 2018-205134, for example. The calculation unit 121 outputs the detected flow rate Qo as the generated output signal.

The detected flow rate Qo as an output signal output from the calculation unit 121 is input to the signal extraction unit 122. The signal extraction unit 122 extracts an AC component Qhpf of the input detected flow rate Qo. The signal extraction unit 122 includes, for example, a high-pass filter filter (HPF). The signal extraction unit 122 outputs the extracted AC component Qhpf to the first correction unit 123.

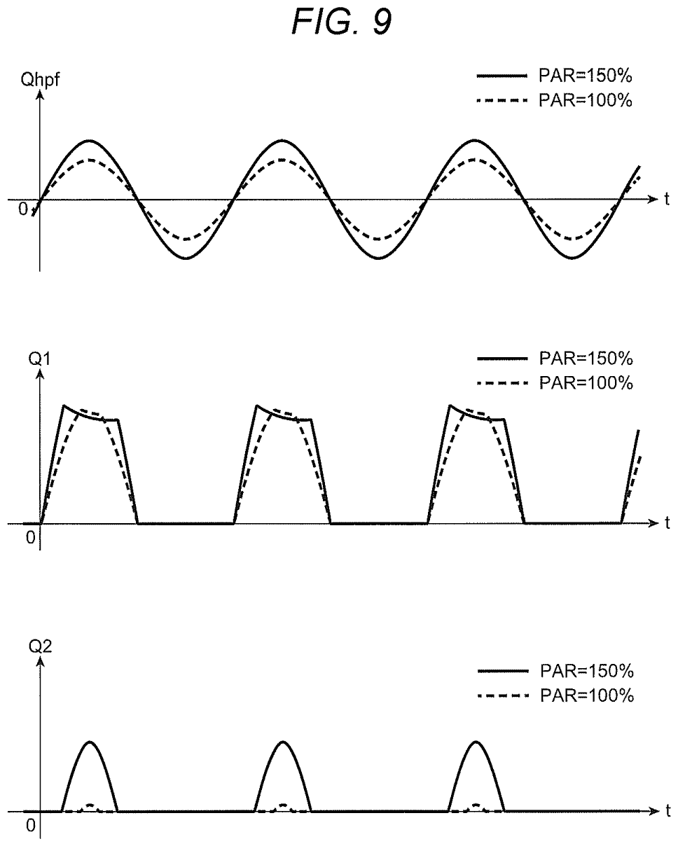

FIG. 9 is a graph for explaining signal processing by the signal processing unit 120 in FIG. 8. The horizontal axis of each graph in FIG. 9 is time t. The uppermost graph in FIG. 9 is the AC component Qhpf extracted by the signal extraction unit 122 from the detected flow rate Qo which is the output signal of the flow rate detection element 111. In FIG. 9, a broken line and a solid line indicate a case where the pulsation amplitude ratio PAR of the air flowing through the main passage 22 is 150% and a case where the pulsation amplitude ratio PAR is 100%, respectively.

The second graph from the top in FIG. 9 illustrates a first correction amount Q1 output from the first correction unit 123. The AC component Qhpf of the detected flow rate Qo output from the signal extraction unit 122 is input to the first correction unit 123. The first correction unit 123 includes, for example, a half-wave rectifier, and generates a half-wave rectified wave of the AC component Qhpf input from the signal extraction unit 122.

Further, the first correction unit 123 outputs the first correction amount Q1 that corresponds to the half-wave rectified wave of the AC component Qhpf and increases according to the increase in the pulsation amplitude ratio PAR of the air flowing through the main passage 22. More specifically, for example, the first correction unit 123 outputs the first correction amount Q1 that increases according to the increase in the pulsation amplitude ratio PAR of the AC component Qhpf until the pulsation amplitude ratio PAR of the AC component Qhpf exceeds a first threshold th1.

For example, when the pulsation amplitude ratio PAR of the air flowing through the main passage 22 exceeds the first threshold th1, the first correction unit 123 limits the first correction amount Q1 to the first correction amount Q1 when the pulsation amplitude ratio PAR of the AC component Qhpf is the first threshold th1. The first threshold th1 can be set to, for example, a maximum value of the first correction amount Q1 corresponding to an arbitrary pulsation amplitude ratio PAR in a low pulsation amplitude region where the positive error of the detected flow rate Qo increases and the pulsation error PAE becomes maximum.

More specifically, the first threshold th1 can be set to, for example, the first correction amount Q1 of an arbitrary pulsation amplitude ratio PAR of 100% or less at which the pulsation error PAE is maximized. As a result, as illustrated in the second graph from the top in FIG. 9, saturation processing of limiting the first correction amount Q1 when the pulsation amplitude ratio PAR is 150% to the first correction amount Q1 of the pulsation amplitude ratio PAR at which the pulsation error PAE is maximized is performed.

The bottom graph of FIG. 9 illustrates a second correction amount Q2 output from the second correction unit 125. As illustrated in FIG. 8, the AC component Qhpf of the detected flow rate Qo output from the signal extraction unit 122 is input to the first coupling unit 124a. The first coupling unit 124a outputs, for example, a difference obtained by subtracting the maximum value of the first correction amount Q1 corresponding to the first threshold th1 from the AC component Qhpf of the detected flow rate Qo.

The second correction unit 125 receives, for example, the difference output from the coupling unit 124a. For example, the second correction unit 125 outputs the second correction amount Q2 that corresponds to the half-wave rectified wave of the AC component Qhpf and increases according to the increase in the pulsation amplitude ratio PAR. For example, the second correction unit 125 outputs the second correction amount Q2 until the pulsation amplitude ratio PAR exceeds the first threshold th1 and reaches a second threshold th2.

For example, when the pulsation amplitude ratio PAR exceeds the second threshold th2, the second correction unit 125 limits the second correction amount Q2 to the second correction amount Q2 when the pulsation amplitude ratio PAR is the second threshold th2. More specifically, when the pulsation amplitude ratio PAR in the low pulsation amplitude region is 100% or less, the second threshold th2 can be set to the maximum value of the second correction amount Q2 of the pulsation amplitude ratio PAR of 100% that is the upper limit of the low pulsation amplitude region where the pulsation error PAE increases.

The first correction amount Q1 output from the first correction unit 123 and the second correction amount Q2 output from the second correction unit 125 are input to the second coupling unit 124b. The second coupling unit 124b outputs a difference obtained by subtracting the second correction amount Q2 from the first correction amount Q1. The third coupling unit 124c receives the difference between the first correction amount Q1 and the second correction amount Q2 output from the second coupling unit 124b and the detected flow rate Qo which is an output signal output from the calculation unit 121.

The coupling unit 124c subtracts a correction amount CA based on the first correction amount Q1 from the detected flow rate Qo which is the output signal. More specifically, the coupling unit 124c subtracts the correction amount CA obtained by subtracting the second correction amount Q2 from the first correction amount Q1 from the detected flow rate Qo, and outputs the subtracted detected flow rate Qo as a corrected flow rate Qc which is the corrected detected flow rate Qo.

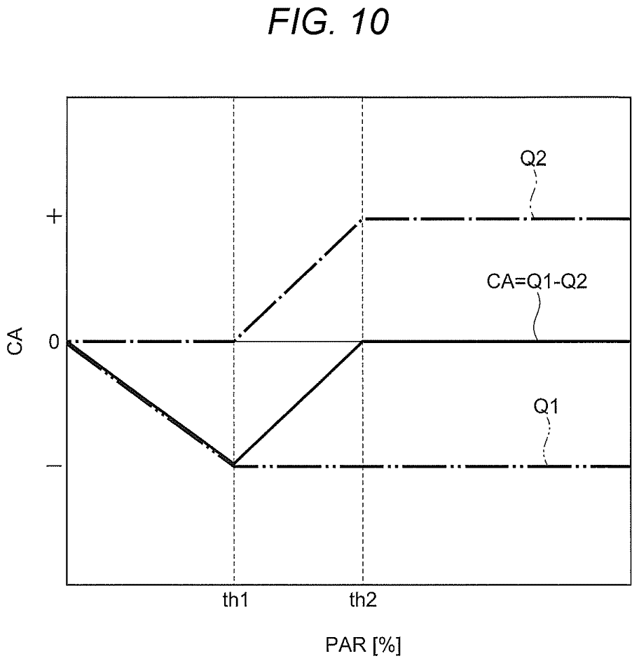

FIG. 10 is a graph illustrating an example of a change in the correction amount CA by the signal processing unit 120 in FIG. 8. As indicated by a two-dot chain line in FIG. 10, the first correction amount Q1 increases at a constant rate until the pulsation amplitude ratio PAR reaches the first threshold th1, and is limited to a predetermined value when the pulsation amplitude ratio PAR exceeds the first threshold th1. On the other hand, as indicated by a one-dot chain line in FIG. 10, the second correction amount Q2 increases at a constant rate until the pulsation amplitude ratio PAR reaches the second threshold th2 when the pulsation amplitude ratio PAR exceeds the first threshold th1, and is limited to a predetermined value when the pulsation amplitude ratio PAR exceeds the second threshold th2.

As a result, as indicated by a solid line in FIG. 10, the absolute value of the correction amount CA increases with the increase in the pulsation amplitude ratio PAR until the pulsation amplitude ratio PAR reaches the first threshold th1. In addition, until the pulsation amplitude ratio PAR exceeds the first threshold th1 and reaches the second threshold th2, the absolute value of the correction amount CA decreases as the pulsation amplitude ratio PAR increases. Further, when the pulsation amplitude ratio PAR exceeds the second threshold th2, the absolute value of the correction amount CA becomes minimum, for example, zero.

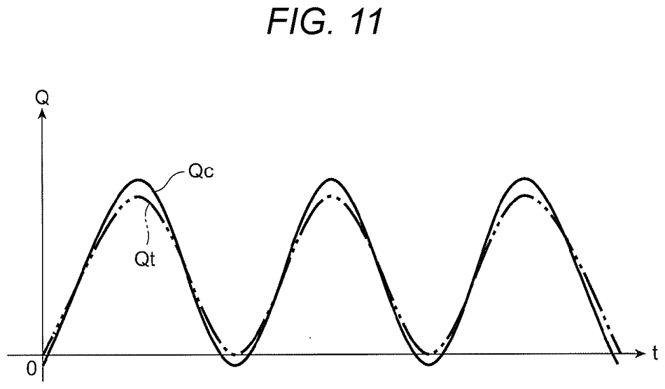

FIG. 11 is a graph illustrating an error between the corrected flow rate Qc and the true flow rate Qt by the signal processing unit 120 of FIG. 8. In the air flow meter 100 of the present embodiment, the signal processing unit 120 executes processing of adding the negative correction amount CA illustrated in FIG. 10 to the detected flow rate Qo which is the output signal of the calculation unit 121, that is, processing of subtracting the correction amount CA from the detected flow rate Qo. As a result, as illustrated in FIG. 6, the detected flow rate Qo in the low pulsation amplitude region where the positive error with respect to the true flow rate Qt increases can be corrected to the corrected flow rate Qc that accurately follows the true flow rate Qt as illustrated in FIG. 11.

As described above, the air flow meter 100 of the present embodiment is the air flow meter 100 that measures the flow rate of the air as the measurement target gas 2 flowing through the main passage 22. As described above, the air flow meter 100 includes the flow rate detection element 111, the calculation unit 121, the signal extraction unit 122, the first correction unit 123, and the coupling unit 124c. The flow rate detection element 111 is installed in the sub-passage 234 that takes air from the main passage 22 and returns the air to the main passage 22, and outputs a detection signal DS corresponding to the flow rate of the air flowing through the sub-passage 234. The calculation unit 121 generates the detected flow rate Qo as an output signal corresponding to the flow rate of the air flowing through the main passage 22 based on the detection signal DS. The signal extraction unit 122 extracts an AC component Qhpf of the detected flow rate Qo as an output signal. The first correction unit 123 outputs a first correction amount Q1 that corresponds to the half-wave rectified wave of the AC component Qhpf and increases according to an increase in the pulsation amplitude ratio PAR of the air flowing through the main passage 22. The coupling unit 124c subtracts the corrected flow rate Qc based on the first correction amount Q1 from the detected flow rate Qo as the output signal.

With such a configuration, the detected flow rate Qo of the air flow meter 100 with respect to the true flow rate Qt can be corrected to reduce the pulsation error PAE. More specifically, for example, the first threshold th1 of the pulsation amplitude ratio PAR illustrated in FIG. 10 is set to an arbitrary pulsation amplitude ratio PAR in a low pulsation amplitude region where the pulsation error PAE is maximized. In this case, the correction amount CA corresponds to the half-wave rectified wave of the AC component Qhpf, and is the first correction amount Q1 that increases according to the increase in the pulsation amplitude ratio PAR of the air flowing through the main passage 22.

The correction amount CA is subtracted from the detected flow rate Qo, which is an output signal of the calculation unit 121 of the air flow meter 100, in a range where the pulsation amplitude ratio PAR illustrated in FIG. 10 is equal to or less than the first threshold th1. As a result, the pulsation error PAE of the corrected flow rate Qc of the air flow meter 100 can be reduced in the pulsation amplitude ratio PAR in the low pulsation amplitude region where the pulsation error PAE increases. Therefore, according to the present embodiment, it is possible to provide the air flow meter 100 capable of measuring the flow rate of the air with high accuracy even in an environment where the pulsation of the air flowing through the main passage 22 increases.

In the air flow meter 100 of the present embodiment, for example, as illustrated in FIG. 10, the first correction unit 123 outputs the first correction amount Q1 that increases according to the increase in the pulsation amplitude ratio PAR until the pulsation amplitude ratio PAR exceeds the first threshold th1. In addition, for example, when the pulsation amplitude ratio PAR exceeds the first threshold th1, the first correction unit 123 limits the first correction amount Q1 to the first correction amount Q1 when the pulsation amplitude ratio PAR is the first threshold th1.

With such a configuration, the air flow meter 100 of the present embodiment can correct the detected flow rate Qo, which is the output signal of the air flow meter 100, limited to the pulsation amplitude ratio PAR in the low pulsation amplitude region where the pulsation error PAE increases. That is, in the pulsation amplitude ratio PAR in the high pulsation amplitude region, the pulsation error PAE of the detected flow rate Qo of the air flow meter 100 is smaller than the pulsation error PAE in the pulsation amplitude ratio PAR in the low pulsation amplitude region. Therefore, the first threshold th1 is, for example, an arbitrary pulsation amplitude ratio PAR in the low pulsation amplitude region where the pulsation error PAE is maximized. As a result, the correction amount CA based on the first correction amount Q1 is limited in the pulsation amplitude ratio PAR in the high pulsation amplitude region where the pulsation error PAE decreases, and the error of the corrected flow rate Qc can be reduced only in the low pulsation amplitude region.

The air flow meter 100 of the present embodiment further includes the second correction unit 125 that outputs the second correction amount Q2 that corresponds to the half-wave rectified wave of the AC component Qhpf of the detected flow rate Qo and increases according to the increase in the pulsation amplitude ratio PAR. The second correction unit 125 outputs the second correction amount Q2 that increases according to the increase in the pulsation amplitude ratio PAR until the pulsation amplitude ratio PAR exceeds the first threshold th1 and reaches the second threshold th2. In addition, when the pulsation amplitude ratio PAR exceeds the second threshold th2, the second correction unit 125 limits the second correction amount Q2 to the second correction amount Q2 when the pulsation amplitude ratio PAR is the second threshold th2. Then, the coupling unit 124c subtracts the correction amount CA obtained by subtracting the second correction amount Q2 from the first correction amount Q1 from the detected flow rate Qo as the output signal.

With such a configuration, the air flow meter 100 of the present embodiment can correct the detected flow rate Qo, which is the output signal of the air flow meter 100, limited to the pulsation amplitude ratio PAR in the low pulsation amplitude region where the pulsation error PAE increases. That is, in the pulsation amplitude ratio PAR in the high pulsation amplitude region, the pulsation error PAE of the detected flow rate Qo of the air flow meter 100 is smaller than the pulsation error PAE in the pulsation amplitude ratio PAR in the low pulsation amplitude region. Therefore, the first threshold th1 is, for example, an arbitrary pulsation amplitude ratio PAR in the low pulsation amplitude region where the pulsation error PAE is maximized, and the second threshold th2 is, for example, an upper limit value of the low pulsation amplitude region. As a result, in the pulsation amplitude ratio PAR in the high pulsation amplitude region where the pulsation amplitude ratio PAR is higher than the second threshold th2, the correction amount CA based on the first correction amount Q1 is canceled by the second correction amount Q2 and reduced, and the error of the corrected flow rate Qc can be reduced only in the low pulsation amplitude region.

In the air flow meter 100 of the present embodiment, the calculation unit 121 calculates the detected flow rate Qo as the output signal from the detection signal DS of the flow rate detection element 111 using the inverse function model IFM. With such a configuration, the air flow meter 100 of the present embodiment can suppress the variation in the detected flow rate Qo due to the variation in the detection signal DS of the flow rate detection element 111.

As described above, according to the present embodiment, it is possible to provide the air flow meter 100 capable of measuring the flow rate of the air in the main passage 22 with high accuracy even in an environment where the pulsation of the air in the main passage 22 increases.

### Second Embodiment

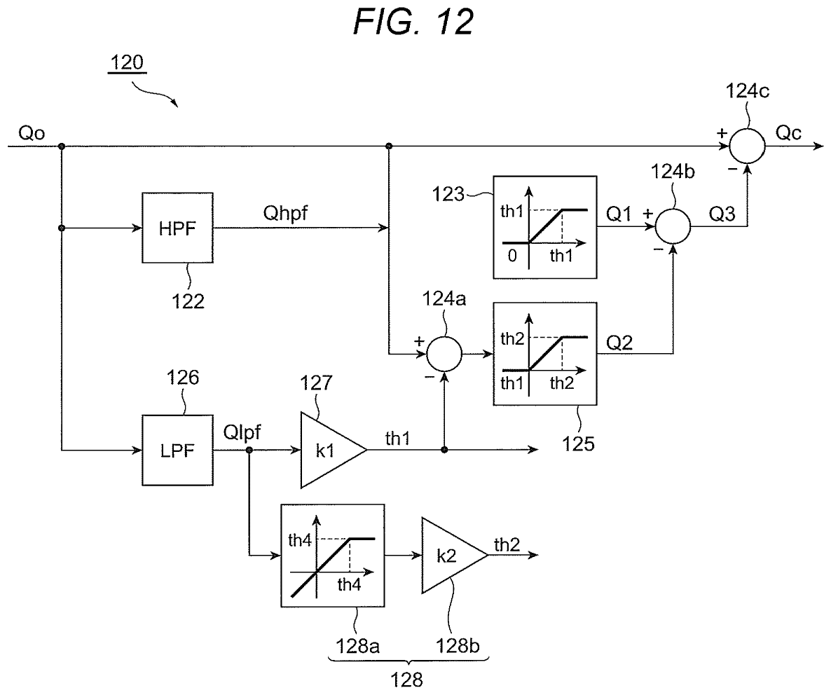

Next, with reference to FIG. 1 to FIG. 7 and FIG. 9 to FIG. 11 of the above-described first embodiment, a second embodiment of an air flow meter according to the present disclosure will be described with reference to FIG. 12. FIG. 2 is a block diagram of a signal processing unit 120 of the second embodiment of the air flow meter according to the present disclosure.

As illustrated in FIG. 12, the signal processing unit 120 of an air flow meter 100 of the present embodiment is different from the air flow meter 100 of the above-described first embodiment in further including an average value output unit 126, a first threshold output unit 127, and a second threshold output unit 128. Since the other configurations of the air flow meter 100 of the present embodiment are similar to those of the above-described air flow meter 100 of the first embodiment, the same reference numerals are given to the same portions, and the description thereof will be omitted.

The detected flow rate Qo as an output signal output from the calculation unit 121 is input to the average value output unit 126. The average value output unit 126 includes, for example, a low-pass filter (LPF), and outputs an average value Qlpf of the detected flow rate Qo which is an output signal. The average value Qlpf of the detected flow rate Qo output from the average value output unit 126 is input to the first threshold output unit 127. For example, the first threshold output unit 127 multiplies the average value Qlpf of the detected flow rate Qo by a gain k1 and outputs a first threshold th1 proportional to the average value Qlpf.

The average value Qlpf of the detected flow rate Qo output from the average value output unit 126 is input to the second threshold output unit 128. The second threshold output unit 128 outputs a second threshold th2 that increases according to the average value Qlpf of the detected flow rates Qo. More specifically, the second threshold output unit 128 includes, for example, a second threshold calculation unit 128a and a gain multiplication unit 128b.

For example, the second threshold calculation unit 128a outputs a correction value that increases according to the average value Qlpf until the average value Qlpf reaches a predetermined threshold th4. For example, when the average value Qlpf exceeds the predetermined threshold th4, the second threshold calculation unit 128a outputs the correction value when the average value Qlpf is the predetermined threshold th4. The gain multiplication unit 128b receives the correction value output from the second threshold calculation unit 128a. The gain multiplication unit 128b outputs a second threshold th2 obtained by multiplying the input correction value by a gain k2.

As described above, the air flow meter 100 of the present embodiment further includes the average value output unit 126, the first threshold output unit 127, and the second threshold output unit 128 in addition to the configuration of the air flow meter 100 of the above-described first embodiment. The average value output unit 126 outputs an average value Qlpf of the detected flow rate Qo which is an output signal of the calculation unit 121. The first threshold output unit 127 outputs a first threshold th1 proportional to the average value Qlpf. The second threshold output unit 128 outputs a second threshold th2 that increases according to an increase in the average value Qlpf.

With such a configuration, the air flow meter 100 of the present embodiment can change the first threshold th1 and the second threshold th2 of the pulsation amplitude ratio PAR according to the average value Qlpf of the detected flow rate Qo output from the calculation unit 121. Therefore, the air flow meter 100 of the present embodiment can not only achieve the same effect as the air flow meter 100 of the above-described first embodiment, but also determine the appropriate first threshold th1 and second threshold th2 according to the average value Qlpf of the detected flow rates Qo.

Although the embodiment of the air flow meter according to the present disclosure has been described in detail with reference to the drawings, the specific configuration is not limited to this embodiment, and design changes and the like without departing from the gist of the present disclosure are included in the present disclosure.

### REFERENCE SIGNS LIST

2 measurement target gas (air)
22 main passage
100 air flow meter
111 flow rate detection element
121 calculation unit
122 signal extraction unit
123 first correction unit
124a coupling portion
125 second correction unit
126 average value output unit
127 first threshold output unit
128 second threshold output unit
234 sub-passage
CA correction amount
DS detection signal
IFM inverse function model
PAR pulsation amplitude ratio
Q1 first correction amount
Q2 second correction amount
Qhpf AC component
Qlpf average value
Qo detected flow rate (output signal)
th1 first threshold
th2 second threshold

1. An air flow meter that measures a flow rate of air flowing through a main passage, the air flow meter comprising:
a flow rate detection element that is installed in a sub-passage that takes the air from the main passage and returns the air to the main passage, and outputs a detection signal corresponding to a flow rate of the air flowing through the sub-passage;
a calculation unit that generates an output signal corresponding to a flow rate of air flowing through the main passage based on the detection signal;
a signal extraction unit that extracts an AC component of the output signal;
a first correction unit that outputs a first correction amount corresponding to a half-wave rectified wave of the AC component and increasing according to an increase in a pulsation amplitude ratio of the air flowing through the main passage; and
a coupling unit that subtracts a correction amount based on the first correction amount from the output signal.

2. The air flow meter according to claim 1, wherein the first correction unit
outputs the first correction amount until the pulsation amplitude ratio exceeds a first threshold, and
when the pulsation amplitude ratio exceeds the first threshold, limits the first correction amount to the first correction amount when the pulsation amplitude ratio is the first threshold.

3. The air flow meter according to claim 2, further comprising a second correction unit that outputs a second correction amount corresponding to the half-wave rectified wave of the AC component and increasing according to an increase in the pulsation amplitude ratio, wherein
the second correction unit
outputs the second correction amount until the pulsation amplitude ratio exceeds the first threshold and reaches a second threshold,
when the pulsation amplitude ratio exceeds the second threshold, limits the second correction amount to the second correction amount when the pulsation amplitude ratio is the second threshold, and
the coupling unit subtracts the correction amount obtained by subtracting the second correction amount from the first correction amount from the output signal.

4. The air flow meter according to claim 3, further comprising:
an average value output unit that outputs an average value of the output signals of the calculation unit;
a first threshold output unit that outputs the first threshold proportional to the average value; and
a second threshold output unit that outputs the second threshold that increases according to an increase in the average value.

5. The air flow meter according to claim 1, wherein the calculation unit calculates the output signal from the detection signal using an inverse function model.
